(19) United States
(12) Patent Application Publication
(10) Pub. No.: US 2010/0048135 A1
(43) Pub. Date: Feb. 25, 2010

(54) HEADSET AND EARPHONE

(75) Inventor: Stefan Marten, Wedemark (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co. KG, Wedemark (DE)

(21) Appl. No.: 12/543,963

(22) Filed: Aug. 19, 2009

(30) Foreign Application Priority Data
Aug. 20, 2008 (DE) 10 2008 039 217.0

(51) Int. Cl. H04B 7/00

(52) U.S. Cl. 455/41.3; 455/575.2

(57) ABSTRACT

There is provided a headset comprising a cable (200), an operating portion (500) displaceable along the cable (200) and having a wireless transmitting unit (510) for wirelessly transmitting control signals and a wireless receiving unit (110) for wirelessly receiving the control signals wirelessly transmitted by the wireless transmitting unit (510).

The present invention concerns a headset and an earphone.

With headsets which are used in aviation or for example for air traffic control it can happen that operating elements are provided in a housing in the connecting cable. Those operating elements can represent for example volume regulators, PTT-keys, on/off switches, mono/stereo change-over switches and so forth. In that respect it is to be noted that the position of the operating portion in the cable must be possible for different spatial factors and thus variable.

To achieve suitable variability hitherto there were provided headsets having a different cable length both in front of and behind the housing for the operating elements.

Therefore an object of the present invention is to provide a headset or an earphone having a cable and at least one operating portion which permits more variable use.

That object is attained by a headset as set forth in claim 1 and by an earphone as set forth in claim 3.

Thus there is provided a headset comprising a cable, an operating portion displaceable along the cable and having a wireless transmitting unit for wirelessly transmitting control signals, and a wireless receiving unit for wirelessly receiving the control signals wirelessly transmitted by the wireless transmitting unit.

In accordance with an aspect of the invention the cable is coupled to a plug for a microphone. The plug is couplable to an interface to transmit a feed voltage for the microphone. The current supply for the wireless receiving unit is effected by the feed voltage of the microphone.

The invention also concerns an earphone comprising a cable, an operating portion displaceable along the cable and having a wireless transmitting unit for wirelessly transmitting control signals and a wireless receiving unit for wirelessly receiving the control signals wirelessly transmitted by the wireless transmitting unit.

The invention concerns the notion of providing on the cable of an earphone or a headset an operating portion or element which is variable in its position along the cable. In that respect the electrical information produced by the settings of the operating elements can be wirelessly transmitted to the headset or the headphone. For that purpose the headset or the headphone can have a wireless transmitting unit which can receive the information wirelessly transmitted by the operating portion and can forward it to the electronic system of the headset or the headphone. Transmission can be implemented inductively, by high frequency or in wattless mode, for example using the RF-ID principle. Optionally the microphone feed for electret microphones can be used as a supply voltage for the receiving portion and as a charging current for batteries in the operating portion.

Further configurations of the invention are subject-matter of the appendant claims.

Advantages and further embodiments by way of example of the invention are described in greater detail hereinafter with reference to the drawings.

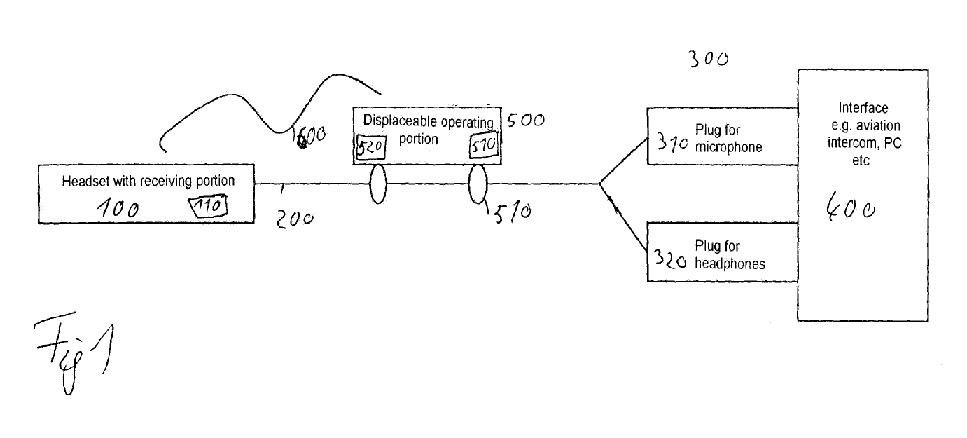

FIG. 1 shows a diagrammatic view of a headset or a headphone according to a first embodiment.

FIG. 1 shows a diagrammatic view of a headset or a headphone according to a first embodiment. A headset 100 is connected by way of a cable 200 to a plug unit 300 which in turn can be coupled to an interface 400. In this case the interface 400 can represent an aviation intercom or a PC interface. The headset 100 can have a wireless receiving unit 110. An operating portion 500 can be provided along the cable 200 and is adapted to be displaceable along the cable. The cable 200 can be connected both to a plug 310 for a microphone and also to a plug 320 for a headphone.

The displaceable operating portion 500 can have for example one, two or more displacement units 510, by means of which the operating portion 500 can be displaced along the cable 200. The geometric configuration of the displacement units 510 must be such that the operating portion can be readily displaced along the cable and possibly arrested.

The operating portion 500 can have a wireless transmitting unit 510 and at least one operating element 520. Those operating elements can represent for example volume regulators, PTT-keys, on/off switches, mono/stereo change-over switches and so forth. The settings or items of information set by the operating elements 520 can be wirelessly transmitted by means of the wireless transmitting unit 510. The wireless receiving unit 110 in the headset is adapted to receive the control signals wirelessly transmitted by the wireless transmitting unit 510 and to forward them to the electronic system of the headset.

The current supply for the operating portion 500 can be provided by way of a battery or an accumulator. As an alternative thereto it is possible to implement a current-less operating portion by wattless keys. The current supply for the receiving unit 110 in the headset can be implemented by batteries or accumulators. As an alternative or in addition thereto the feed voltage of the electret microphone can be used for the current supply of the receiving portion 110.

Although a headset has been described and shown in FIG. 1 the basic notion of the invention can also be applied to a headphone or an earphone. Thus there can be provided an earphone having a cable 200, wherein an operating portion 500 is adapted to be displaceable along the cable 200. The operating portion 500 can have a wireless transmitting unit 510 and operating elements 520. Control signals produced by the operating elements 520 can be wirelessly transmitted by means of the wireless transmitting unit 510 to a receiving unit 110 in the earphone. The current supply of the operating portion 500 can be provided for example by way of an accumulator.

1. A headset comprising:
a cable,
an operating portion displaceable along the cable and having a wireless transmitting unit for wirelessly transmitting control signals, and
a wireless receiving unit for wirelessly receiving the control signals wirelessly transmitted by the wireless transmitting unit.

2. A headset as set forth in claim 1 wherein the cable is coupled to a plug for a microphone, wherein the plug is couplable to an interface to transmit a feed voltage for the microphone, wherein the current supply of the wireless receiving unit is effected by the feed voltage of the microphone.

3. An earphone comprising:
a cable,
an operating portion displaceable along the cable and having a wireless transmitting unit for wirelessly transmitting control signals, and
a wireless receiving unit for wirelessly receiving the control signals wirelessly transmitted by the wireless transmitting unit.
